(19) United States
(12) Patent Application Publication
(10) Pub. No.: US 2002/0119904 A1
(43) Pub. Date: Aug. 29, 2002

(54) Cleaning compositions

(75) Inventors: Jelles Vincent Boskamp, Vlaardingen (NL); Ian Charles Callaghan, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/025,240

(22) Filed: Dec. 19, 2001

(30) Foreign Application Priority Data
Dec. 21, 2000 (EP) 00204764.5

(51) Int. Cl. C11D 17/00

(52) U.S. Cl. 510/445; 510/447; 510/462

(57) ABSTRACT

The invention provides a tablet of compacted particulate cleaning composition comprising at least one cleaning ingredient selected from the group consisting of organic surfactant, detergency builder and bleach, wherein the tablet or a discrete region thereof comprises water-swellable disintegration-promoting particles comprising a) disintegration material selected from the group consisting of (i) cellulosic material from a plant source other than timber and (ii) plant material which contains both cellulose and lignin, obtainable by fragmentation of plant material without separation of its fibers into a liquid dispersion, and b) carrier material having a solubility in deionised water at 20° C. of about 1 gram per liter or less. The tablets have an aesthetically acceptable colour and exhibit good disintegration and strength properties. The disintegration-promoting particles are also provided.

This invention relates to cleaning compositions in the form of tablets. These tablets are intended to disintegrate when placed in water and thus are intended to be consumed in a single use. The tablets may be suitable for use in machine dishwashing, the washing of fabrics or other cleaning tasks.

Detergent compositions in tablet form and intended for fabric washing have been described in many documents including, for example, GB-A-911204 (Unilever), WO 90/02165 (Henkel) and EP-A-711827 (Unilever) and are now sold commercially. Tablets containing bleach for use as an additive to a fabric washing liquor have been disclosed in U.S. Pat. No. 4,013,581 (Huber/Procter and Gamble). Tablets containing a water softening agent, for use as an additive in cleaning, are sold commercially and are one form of tablet disclosed in EP-A-838519 (Unilever). Tablets of composition suitable for machine dishwashing are sold commercially.

Tablets have several advantages over powdered products: they do not require measuring and are thus easier to handle and dispense into the washload, and they are more compact, hence facilitating more economical storage and transport.

Tablets of a cleaning composition are generally made by compressing or compacting a composition in particulate form. Although it is desirable that tablets have adequate strength when dry, yet disperse and dissolve quickly when brought into contact with water, it can be difficult to obtain both properties together. Tablets formed using a low compaction pressure tend to crumble and disintegrate on handling and packing; while more forcefully compacted tablets may be sufficiently cohesive but then fail to disintegrate or disperse to an adequate extent in the wash. Tabletting will often be carried out with enough pressure to achieve a compromise between these desirable but antagonistic properties. However, it remains desirable to improve one or other of these properties without detriment to the other so as to improve the overall compromise.

If a tablet contains organic surfactant, this functions as a binder, plasticising the tablet. However, it can also retard disintegration of the tablet by forming a viscous gel when the tablet comes into contact with water. Thus, the presence of surfactant can make it more difficult to achieve both good strength and speed of disintegration: the problem has proved especially acute with tablets formed by compressing powders containing surfactant and built with insoluble detergency builder such as sodium aluminosilicate (zeolite).

The use of crude cellulosic particles such as sawdust or wood flour was suggested many years ago in U.S. Pat. No. 2,560,097, but in the context of one-use tablets for hand-washing where the material serves as a filler and the tablets were disintegrated in use by handling.

It is known to include materials whose function is to enhance disintegration of tablets when placed in wash water. For example, our EP-A-838519 mentioned above teaches the use of sodium acetate trihydrate for this purpose.

Generally the above soluble compounds are produced by synthetic reactions. Alternatives to these soluble compounds are always being sought from ‘renewable’ sources, such as cellulose, in order to increase the ‘natural’ content of detergent tablets. A more ‘natural’ product is becoming increasingly desired by consumers.

A number of documents have taught that the disintegration of tablets of cleaning composition can be accelerated by incorporating in the tablet a quantity of a water-insoluble but water-swellable polymeric material. Such documents include WO 98/40462, WO 98/40463, WO 98/55575, WO 98/55582 and WO 98/55583. Cellulosic granules are also disclosed in DE 199 01 063 A (Henkel KGAA). These documents disclose the use of cellulosic material derived from timber and subjected to a substantial amount of pretreatment before incorporation into tablets. In some instances the cellulosic fibres are separated from the raw material, dispersed in water and then recovered using a process analogous to papermaking. WO 98/40462 mentions the use of a material known in the papermaking industry as “Thermomechanical pulp”. Fibres obtained from timber by mechanical processing combined with dispersion in water generally contain 35% or more of cellulose and 30% or less of lignin. Other references disclosing cellulose based disintegrant granules are EP-A-0-879 599 (Firma Celcommerz High-Chem Produkte GmbH) and EP-A-1-043-391 (Stockhausen GmbH).

Cellulose fibres may be chemically treated to remove this lignin as is done when making high quality white paper. In the papermaking industry the resulting purified fibres are referred to a “chemical fibres”.

A number of plant sources (as well as timber) have been recognised as sources of natural fibre useful for making textiles (which may be coarse textiles such as sacking), rope or twine. These include such plants as agave which is a source of sisal, jute, flax and hemp plants which are sources of fibres with the same names, and the ceiba tree whose seed capsules yield kapok. If the water-swellable disintegrant material comes from one of these plants, it may be provided by the plant fibres (as might be used for textile or rope making) comminuted to a given particle size, or, it may be provided by residues of the fibrous material after the separation of longer fibres. The disintegration-promoting particles may be particles of a cellulose-containing fibrous material originating from a plant source other than timber. This may be the fruit of a plant or the stem of a plant other than a tree. These materials will generally also include lignin and thus can be termed “lignocellulosic”.

We have previously found that a good speed of tablet disintegration and satisfactory tablet strength can be achieved through the use of cellulosic material which does not come from the wood of trees (timber), or, plant material which contains both cellulose and lignin, obtainable by fragmentation of plant material without separation of its fibers into a liquid dispersion in the tablet as disclosed in our WO-A-00/77152 and WO-A-00/77153.

However a disadvantage with the types of materials disclosed in our WO-A-00/77152 and WO-A-00/77153 is that when they are used as a disintegrant material for tabletted cleaning compositions (detergent compositions), their naturally dark colour can discolour or darken the cleaning compositions and/or may leave residues on articles treated with tablets comprising such disintegrant materials. This may make the tablet less attractive to the consumer as their appearance may be seen as discoloured and thus less aesthetically pleasing than a lighter coloured alternatively. Any residues left on treated articles are also noticeable from darker coloured materials.

Thus, there is a need in the art to be able to incorporate the aforementioned types of naturally dark coloured disintegrant materials into said tablets, in effective amounts, whilst maintaining an attractive appearance thereof for the consumer. It is also desirable to avoid the need to colour the tablet to disguise any discolouration from the inclusion of the disintegrant material.

It is an aim of the present invention to provide a tablet of cleaning composition comprising an effective amount of said types of naturally dark coloured disintegrant materials, which tablets have an acceptable appearance to the consumer. Additionally, it is an aim of the invention to provide tablets of cleaning composition which do not result in unacceptably high levels of noticeable residues.

We have now found that the above can be achieved by mixing said naturally dark coloured types of disintegrant materials with certain carrier materials to form a water-swellable disintegration-promoting particle which can be incorporated into the tablet of compacted cleaning material. The present invention provides tablets with acceptable aesthetic properties and disintegration and strength properties.

This result is surprising because it would not be expected that the problem of the discoloration of the tablet could be overcome whilst still providing effective disintegration of the tablet. It would be expected that in order to provide effective tablet disintegration a given amount of said naturally dark coloured types of disintegrant material would be required which would in turn discolour the tablet, even if this disintegrant material was mixed with other materials.

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

Thus, according to a first aspect of this invention, there is provided a tablet of compacted particulate cleaning composition comprising at least one cleaning ingredient which is an organic surfactant, detergency builder or a bleach, wherein the tablet or a discrete region thereof comprises water-swellable disintegration-promoting particles, said particles comprising;

a) disintegration material which is (i) cellulosic material from a plant source other than timber or (ii) plant material which comprises both cellulose and lignin, obtainable by fragmentation of plant material without separation of its fibers into a liquid dispersion, and

b) carrier material which has a solubility in deionised water at 20° C. of 1 gram per liter or less.

A preferred material to be employed as the disintegration material a) of type (i) is particles of coconut husk material, sometimes known as coir. A preferred form of cellulosic plant disintegration material a) according to type ii) is woodchip or sawdust, which may be milled to a smaller particle size within the preferred range herein. Mixtures of the disintegration materials of types (i) and (ii) may also be used.

A preferred material to be employed as the disintegration material a) of type (i) is a clay, especially a smectite clay.

In a second aspect this invention provides a process for making a tablet of compacted particulate cleaning composition or a region thereof comprising at least one cleaning ingredient which is an organic surfactant, detergency builder or a bleach, which process comprises mixing water-swellable disintegration-promoting particles comprising a) disintegration material which is (i) cellulosic material from a plant source other than timber or (ii) plant material which contains both cellulose and lignin, obtainable by fragmentation of plant material without separation of its fibers into a liquid dispersion and b) carrier material which has a solubility in deionised water at 20° C. of 1 gram per liter or less, with other particulate ingredients to form a particulate cleaning composition and compacting a quantity of the particulate cleaning composition in a mould to form the tablet or region thereof.

In a third aspect this invention provides water-swellable disintegration-promoting particle comprising;

a) disintegration material which is (i) cellulosic material from a plant source other than timber or (ii) plant material which contains both cellulose and lignin, obtainable by fragmentation of plant material without separation of its fibers into a liquid dispersion, and

b) carrier material which has a solubility in deionised water at 20° C. of 1 gram per liter or less.

It is especially preferred that the disintegration material a) comprises coconut husk material. An especially preferred combination is coconut husk material with a clay, especially a smectite clay such as bentonite clay.

In a fourth aspect the invention provides a process for making water-swellable disintegration-promoting particles, said process comprising the steps of contacting;

a) disintegration material which is (i) cellulosic material from a plant source other than timber or (ii) plant material which contains both cellulose and lignin, obtainable by fragmentation of plant material without separation of its fibers into a liquid dispersion, with

b) carrier material which has a solubility in deionised water at 20° C. of 1 gram per liter or less, to produce a mixture and compacting the mixture to produce the particles.

This invention has the advantage that it provides effective disintegration of the tablet using natural materials, whilst, providing a tablet appearance that is still acceptable to the consumer.

The solubility of the carrier material b) is measured in deionised water at 20° C. at pH 7.

This invention is particularly applicable when the tablets contain both surfactant and detergency builder, as in tablets for fabric washing or machine dishwashing.

Forms of this invention, preferred and optional features, and materials which may be used, will now be discussed in greater detail.

Discrete Regions/Whole Tablets

A tablet of this invention may be either homogeneous or heterogeneous. In the present specification, the term “homogeneous” is used to mean a tablet produced by compaction of a single particulate composition, but does not imply that all the particles of that composition will necessarily be of identical composition. The term “heterogeneous” is used to mean a tablet consisting of a plurality of discrete regions, for example layers, inserts or coatings, each of which is a matrix of particles derived by compaction from a particulate composition. In a heterogenous tablet according to the present invention, each discrete region of the tablet will preferably have a mass of at least 3 grams.

In a heterogeneous tablet, at least one of the discrete regions contains the said swellable disintegration-promoting particles.

There are a number of possibilities concerning heterogenous tablets. Water-swellable material may or may not be included in every region of a heterogenous tablet, even though the regions differ from each other in some other feature of their composition. Thus the water-swellable material may be present at different concentrations in different tablet regions; it may be present in one region and absent from another; or it may be present at equal concentration in every region of the tablet.

The Water-swellable Disintegration-promoting Particles

The water-swellable disintegration-promoting particles according to the invention comprise disintegration material and a carrier material as herein described.

a) Disintegration Material

The disintegration material is chosen from either (i) cellulosic material from a plant source other than timber or (ii) plant material which contains both cellulose and lignin, obtainable by fragmentation of plant material without separation of its fibers into a liquid dispersion. Preferably the disintegration material comprises at least 35% by weight lignin, more preferably at least 40% by weight lignin.

It is especially preferred that the disintegration material comprises coconut husk material. Also it is preferred that the disintegration material has an average particle size of 120 micrometers or below, more preferably 100 micrometers or below, most preferably 80 micrometers or below, e.g. 70 micrometers or below, before it is combined with the carrier material to form the water-swellable disintegration-promoting particles.

The particle size as referred to herein is measured by sieving the granules and collecting the sievings. The weight of the sieved fractions is plotted against the particle size of the fractions and the weight average mean particle size is then calculated following the method defined in Rosin and Rammler, J. Inst. Fuel, 7, 29-36 (1933) to give the weight average particle size. All particle sizes referred to herein are to weight average particle sizes determined by this method unless otherwise stated.

If the water-swellable disintegrant material comes from a plant source other than coconut, it may be provided by the plant fibres (as might be used for textile or rope making) comminuted to a particle size as discussed above, or it may be provided by residues of the fibrous material after the separation of longer fibres.

Coconuts, from the tree Cocos nucifera have a fibrous husk (more correctly “mesocarp”) which surrounds the hard shell.

It is conventional to separate the fibres from this husk and utilise them as a coarse textile or rope material termed “coir”. The residue after removal of the fibres can be used in horticulture as a substitute for peat. This material is herein referred to as “cocopeat”.

For this invention the husk material which is used may be fibres from ripe or immature coconuts—the latter give paler fibres. Alternatively the material may be a husk residue which is left after the removal of at least some fibres. In either case the material is comminuted as necessary, e.g. milled, to a suitable particle size.

If desired, this coconut-derived material may be subjected to a bleaching treatment to lighten its colour.

It is a feature of coconut husk material that it contains a high proportion of lignin as well as some cellulose. Typically it contains lignin in an amount which is at least 40% of its overall weight, although this might be reduced in the course of any bleaching treatment, for instance to at least 30% or at least 35% by weight lignin. The amount of lignin may exceed the amount of cellulose. In natural materials, lignin is known to decrease the permeation of water across cell walls, suggesting that the presence of lignin might restrict particle swelling.

Powdered wood, for example prepared from suitable wood chips, may be used as type ii) of the disintegrant material.

The disintegration material may be mixed with a small quantity of surfactant (perhaps in amount from 0.01 to 1% by weight of the water-swellable particles) so that these disintegrant particles do not float on the surface of the wash liquor after the disintegration of a tablet containing them. This mixing may occur either with directly with the disintegration material before it is mixed with the carrier or after the disintegration particle has been formed.

b) Carrier Material

The carrier material has a solubility in deionised water at 20° C. of 1 gram per liter or less prior to being combined with the disintegration material. The carrier material preferably comprises a water-insoluble material.

The carrier material may be, for example, a metal oxide and especially those of the group IV metals such as titanium dioxide, a complex aluminosilicate (such as zeolite), a builder (water softener) material, or a complex carbohydrate provided that the materials chosen have the requisite solubility characteristics. If a complex aluminosilicate is used it may have a weight ratio of Al:SI in the range 0.1 to 0.9.

Using materials that act as a builder (or water softener) has the advantage that the disintegration promoting particles are formed from ingredients that have a functionality when the tablet is used. Suitable examples include zeolites, silicates, silicas, calcium phosphates including calcium orthophosphate and calcium metaphosphate.

Alternatively the carrier material may be any organic or inorganic salt with required solubility characteristics. Suitable examples include calcite (calcium carbonate), calcium magnesium carbonate (dolomite), calcium oxalate, calcium d-tartrate, magnesium carbonate,magnesium oxalate and magnesium orthophosphate. Suitable bleach stabilisation agents which can be used include magnesium metasilicate and magnesium orthosilicate.

One especially suitable complex aluminosilicate is clay. The clay may be a swelling clay or a non-swelling clay although swelling clays are preferred. Especially preferred clays include smectite clays, and bentonite clay has been found to be very effective. It is known to include granules of bentonite clay in laundry tablets as disclosed in DE 199 15 321.

Smectites are 2:1 clay minerals in which aluminium oxide or magnesium are present in a silicate lattice.

Suitable smectite clay minerals include montmorillonite, beidellite, hectorite, nontronite, saponite and sauconite, particularly those having an alkali or alkaline earth metal ion between the clay mineral layers. Montmorillonite is the preferred mineral, and clays which contain a majority of montmorillonite, such as bentonite, are a preferred source of this clay mineral. It may be preferred that the clay is at least 90% montmorillonite. Bentonites containing calcium or sodium montmorillonite (known as calcium or sodium bentonites) are particularly preferred.

Suitable bentonite clays are sold under the trade names of Laundrosil DW, M630 Agglomerat and EX 0276 Agglomerat clays available from Süd Chemie, Germany, Detercal G1 FC and Detercal G2 FC clays, available from Laviosa, Italy, Bentonite QPC 200G and QTIC 200G clay available from Colin Stewart Minerals, UK.

A particularly good combination has been found to be coconut husk material with a clay such as bentonite clay.

It is preferred that the carrier material b) is not substantially darker in colour (when assessed by the naked eye) than the disintegration material a). Preferably the carrier material is lighter in colour than the disintegration material. It is not essential that white or very light coloured material is used as the carrier material but this has an advantage of reducing the overall level of colouration of the water-swellable disintegration promoting particles. However, it is possible to colour the carrier or the disintegration promoting particles, for example by the use of dyestuffs, if desired according to the requirements for the tablet aesthetics.

The degree of colouration (lightness) of the disintegrant material, carrier material and water-swellable disintegration promoting particles can also be measured by the test as described in Commision Internationale d'Eclarage publication 15.2 “colourimetry” Second Edition which is incorporated by reference herein. The test method provides a measurement of the degree of lightness of a material by means of an L (lightness) value in the range 0 to 100. An L value of 100 denotes the lightest material and 0 denotes the darkest material. The L value of the carrier material preferably lies in the range of from 65-100, preferably 75 to 100, more preferably 85-100. Values of a and b are also provided by the test and these denote the colour of the test material. However this is less important than the lightness value of the material.

The water-swellable disintegration-promoting particles preferably comprise the disintegration material a) and the carrier material b) in a weight ratio of 15:85 to 85:15, more preferably 30:70 to 70:30, especially 40:60 to 60:40.

For the higher ratios of the disintegration material a), e.g. 80:20, it may be necessary to use higher-than-usual compaction pressures to form the disintegration-promoting particles as sometimes tablets formed from such disintegration-promoting particles are not sufficiently robust to withstand normal transportation and storage unless higher tablet compaction pressures are used.

The disintegration-promoting particles preferably comprise the disintegration material a) in an amount of from 0.1% to 90% by weight, preferably 15% to 80% or 85% by weight, more preferably 15% or 20% to 50%, 60% or 70% by weight based upon the total weight of the disintegration-promoting particles.

The disintegration-promoting particles preferably comprise the carrier material b) in an amount of from 10% to 99.5% by weight, preferably 20% to 80% or 85% by weight, more preferably 20% or 25% to 60% or 70% by weight based upon the total weight of the disintegration-promoting particles.

Where the amount of disintegration material a) and carrier material b) does not total 100% wt of the granule particle, other material is present in the particle in an amount so that the total weight of these components is 100% wt of the particle.

An example of a disintegration-promoting particle is one comprising 0.5% to 50% by weight of the disintegration material a) and 99.5% to 50% by weight of the carrier material b). Optionally a binder material may also be included in the particle, preferably in an amount of from 0.1 to 10% by weight of the particle.

The water-swellable disintegration-promoting particles may optionally further comprise a binder material. The binder may be present in the particles in an amount of up to 15% or 20% by weight, preferably 0.1% to 10% by weight, more preferably 1 to 5% by weight based upon the total weight of said particles. Preferably the binder is a water-soluble polymer. Especially preferred binders include polyethylene glycols with a molecular weight in the range 300 to 6000.

The water-swellable disintegration-promoting particles preferably have a mean particle size, before contact with water, in a range of from 250 to 1,500 micrometers, more preferably 400 up to 1,100 or 1,500 micrometers. Particularly preferred is a mean particle size in a range from 700 to 1,000 micrometers. It is desirable that substantially all particles larger than 2 mm (2,000 micrometers) are removed, e.g. by sieving.

The mean particle size referred to herein is measured by sieving the material and collecting the sievings. The weight of the sieved fractions is plotted against the particle size of the fractions and the weight average mean particle size is then calculated following the method defined in Rosin and Rammler, J. Inst. Fuel, 7, 29-36 (1933) to give the weight average particle size. All particle sizes referred to herein are weight average particle sizes determined by this method unless otherwise stated.

The water-swellable disintegration-promoting particles are preferably present in the tablet in an amount of 0.1 to 15%, more preferably 0.5 to 10%, most preferably 3 to 9% by weight based on the total weight of the tablet. Especially good results have been found using amounts in the range of 3.5 to 8% by weight e.g. 4.5 to 6% by weight based on the total weight of the tablet.

Where the tablet contains a plurality of discrete regions, the disintegration-promoting particles may be distributed equally or unequally throughout those regions. In a preferred embodiment, a tablet contains a plurality of discrete regions, at least of which contains a greater concentration of the disintegration-promoting particles than another region of the tablet.

The particle density of the water-swellable disintegration-promoting particles is typically in the range of from 0.4 to 2.7 g/cm³, preferably 0.8 to 2.5 g/cm³, more preferably 1.0 to 2.3 g/cm³, more preferably 1.4. to 2.1 g/cm³.

Making the Disintegration-promoting Particles

The water-swellable disintegration-promoting particles may be made by a process comprising the steps of contacting the disintegrant material a) with the carrier material b), and then compacting the resultant mixture, at a suitable pressure and for a suitable time, and if necessary comminuting the compacted mixture into disintegrant particles.

Mixing of these materials can be carried out by standard apparatus for mixing particulate solids. Other ingredients can be incorporated at this stage for example surfactant and binder. If a binder is incorporated, it can be added in particulate form during this mixing operation. Alternatively, if it can be melted, the molten binder can be sprayed on to the mixture or on to one particulate ingredient of the mixture.

Compaction of the mixture can be brought about by forcing it between a pair of rollers. Suitable apparatus—a roller compactor—has a feed screw which delivers the mixture to the nip of the rollers. The speed of the feed screw, and hence the amount of material delivered to the nip of the rollers should be high enough to force an unbroken stream of material through the rollers, but not so high that the material is converted into a dough.

The sheet of material which issues from the rollers is next broken up and milled to the required particle size.

The compaction pressure and compaction time used to compress the mixture to form the disintegration-promoting particles will vary according to the mixture and the compaction apparatus used. The compaction pressure is preferably in the range of from 1000 to 10,000 kg per 15.2 cm², more preferably 2000 to 8000 kg per 15.2 cm², such as 2800 to 8000 kg per 15.2 cm². The compaction times are usually in the range 15 seconds to 2 minutes, for example 30 to 90 seconds, such as about 1 minute.

Manufacturers of both roller compactor and milling machinery include Hosokawa Beper located at Heilbromn, Germany, Alexanderwerk located at Remschied, Germany and Fitzpatrick located at Elmhurst, USA.

If the disintegrant material particles are to be mixed with surfactant as described above, so that they do not end up floating on top of the wash liquor, it is suitable for this purpose to spray them with a liquid anionic surfactant such as Aerosil™ OT, which is the sodium salt of the (2-ethylhexyl) diester of sulphosuccinic acid.

Such a surfactant may be sprayed on in a quantity which is from 0.01 to 10% of the weight of the water-swellable disintegration-promoting particles, preferably from 0.01 to 0.5% of their weight.

Surfactant Compounds

Compositions which are compacted to form tablets, or discrete regions thereof, according to this invention contain one or more non-soap surfactants. In a fabric washing composition, these preferably provide from 5 to 50% by weight of the composition of the tablet or region thereof, more preferably from 8 or 9% by weight of the composition up to 35% or 40% by weight. If the tablet is composed of more than one discrete region, then these preferred amounts of surfactant may apply to the tablet as a whole.

Organic surfactant may be present as forming a component in granulated particles in an amount between 10 and 70% by weight of the particles, more preferably 15 to 50% by weight based on the total weight of the granulated particles. All the surfactant in the composition may be contained within these particles.

The surfactant may be anionic (soap or non-soap), cationic, zwitterionic, amphoteric, nonionic or a combination of these.

In a fabric washing tablet, anionic surfactant may be present in an amount from 0.5 to 50% by weight, preferably from 2% or 4% up to 30% or 35% or 40% by weight of the tablet or region thereof.

For other types of detergent tablet, e.g. in a machine dishwashing composition, organic surfactant is likely to constitute from 0.5 to 8% by weight, more likely from 0.5 to 5% of the composition of the tablet or region thereof and is likely to consist of nonionic surfactant, either alone or in a mixture with anionic surfactant.

Synthetic (i.e. non-soap) anionic surfactants are well known to those skilled in the art. Examples include alkyl benzene sulphonates, particularly sodium linear alkyl benzene sulphonates having an alkyl chain length of C₈-C₁₅; olefin sulphonates; alkane sulphonates; dialkyl sulphosuccinates; and fatty acid ester sulphonates.

Primary alkyl sulphate having the formula:

ROSO₃⁻M⁺

in which R is an alkyl or alkenyl chain of 8 to 18 carbon atoms especially 10 to 14 carbon atoms and M⁺ is a solubilising cation, is commercially significant as an anionic surfactant.

Linear alkyl benzene sulphonate of the formula:

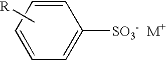

where R is linear alkyl of 8 to 15 carbon atoms and M⁺ is a solubilising cation, especially sodium, is also a commercially significant anionic surfactant.

Frequently such linear alkyl benzene sulphonate or primary alkyl sulphate of the above formula, or a mixture thereof, will be the desired anionic surfactant and may provide 75 to 100 wt % of any anionic non-soap surfactant in the composition.

In some forms of this invention the amount of non-soap anionic surfactant lies in a range from 5 to 20 or 25 wt % of the tablet or region thereof.

It may also be desirable to include one or more soaps of fatty acids. These are preferably sodium soaps derived from naturally occurring fatty acids, for example, the fatty acids from coconut oil, beef tallow, sunflower or hardened rape seed oil.

Suitable nonionic surfactant compounds which may be used include in particular the reaction products of compounds having a hydrophobic group and a reactive hydrogen atom, for example, aliphatic alcohols, acids, amides or alkyl phenols with alkylene oxides, especially ethylene oxide.

Specific nonionic surfactant compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine.

Especially preferred are the primary and secondary alcohol ethoxylates, especially the C₉₋₁₁ and C₁₂₋₁₅ primary and secondary alcohols ethoxylated with an average of from 5 to 20 moles of ethylene oxide per mole of alcohol.

In certain forms of this invention the amount of nonionic surfactant lies in a range from 4 to 40%, better 4 or 5 to 30% by weight of the composition of the tablet or region thereof.

Many nonionic surfactants are liquids. These may be absorbed onto particles of the composition prior to compaction into tablets.

Amphoteric surfactants which may be used jointly with anionic or nonionic surfactants, or both, include amphopropionates of the formula;

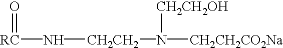

where RCO is a acyl group of 8 to 18 carbon atoms, especially coconut acyl.

The category of amphoteric surfactants also includes amine oxides and also zwitterionic surfactants, notably betaines of the general formula;

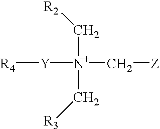

where R₄ is an aliphatic hydrocarbon chain which contains 7 to 17 carbon atoms, R₂ and R₃ are independently hydrogen, alkyl of 1 to 4 carbon atoms or hydroxyalkyl of 1 to 4 carbon atoms such as CH₂OH, Y is CH₂ or of the form CONHCH₂CH₂CH₂ (amidopropyl betaine); Z is either a COO⁻ (carboxybetaine), or of the form CHOHCH₂SO₃ (sulfobetaine or hydroxy sultaine).

Another example of amphoteric surfactant is amine oxide of the formula;

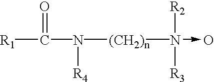

where R₁ is C₁₀ to C₂₀ alkyl or alkenyl; R₂, R₃ and R₄ are each hydrogen or C₁ to C₄ alkyl, while n is from 1 to 5.

Cationic surfactants may possibly be used. These frequently have a quaternised nitrogen atom in a polar head group and an attached hydrocarbon group of sufficient length to be hydrophobic. A general formula for one suitable category of cationic surfactants is;

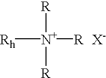

where each R independently denotes an alkyl group or hydroxyalkyl group of 1 to 3 carbon atoms and Rₕ denotes an aromatic, aliphatic or mixed aromatic and aliphatic group of 6 to 24 carbon atoms, preferably an alkyl or alkenyl group of 8 to 22 carbon atoms and X⁻ is a counterion.

The amount of amphoteric surfactant, if any, may possibly be from 3% to 20 or 30% by weight of the tablet or region thereof. The amount of cationic surfactant, if any, may possibly be from 1% to 10 or 20% by weight of the tablet or region thereof.

Detergency Builder

A composition which is compacted to form tablets or tablet regions typically contains an agent which serves to remove or sequester calcium and/or magnesium ions in the water, that is, which acts as a water softener. In the context of a detergent composition containing organic surfactant, a water-softening agent is more usually referred to as a detergency builder.

In detergent tablets the amount of builder is likely to be from 5% to 80%, more usually 10% or 15% to 60% by weight of the tablet. In tablets whose principal or sole function is that of removing water hardness the builders (water-softening agents) may provide from 50 to 98% by weight of the tablet composition.

The detergency builder may be present in granulated particles in an amount of from 20 to 80% by weight, more preferably 30 to 60% by weight.

Detergency builders may be provided wholly by water soluble materials, or may be provided in large part or even entirely by water-insoluble material with water-softening properties.

Alkali metal aluminosilicates are strongly favoured as environmentally acceptable detergency builders for fabric washing, and are preferred in this invention. Alkali metal (preferably sodium) aluminosilicates may be either crystalline or amorphous or mixtures thereof, having the general formula:

0.8-1.5 Na₂O.Al₂O₃. 0.8-6 SiO₂. xH₂O

These materials contain some bound water (indicated as xH₂O) and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature.

Suitable crystalline sodium aluminosilicate ion-exchange materials are described, for example, in GB 1 429 143 (Procter & Gamble). The preferred sodium aluminosilicates of this type are the well known commercially available zeolites A and X and the newer zeolite P described and claimed in EP 384 070 (Unilever) and mixtures thereof. This form of zeolite P is also referred to as “zeolite MAP”. One commercial form of it is denoted “zeolite A24” and is available from Ineos Silicas Ltd, UK.

Conceivably a detergency builder could be a layered sodium silicate as described in U.S. Pat. No. 4 664 839. NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3,417,649 and DE-A-3,742,043. Other such layered silicates, such as those having the general formula NaMSiₓO_{2x+1.}yH₂O wherein M is sodium or hydrogen, x is a number from 1.9 to 4, preferably 2, and y is a number from 0 to 20, preferably 0 can be used.

Water-soluble builders include phosphorus-containing inorganic builders which include the alkali-metal orthophosphates, metaphosphates, pyrophosphates and polyphosphates. Specific examples of inorganic phosphate detergency builders include sodium and potassium tripolyphosphates, orthophosphates and hexametaphosphates.

Non-phosphorus water-soluble detergency builders may be organic or inorganic. Inorganics that may be present include alkali metal (generally sodium) carbonate; while organics include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates. Nitrilotriacetates, such as sodium nitrilotriacetate, may also be present.

Tablet compositions preferably include polycarboxylate polymers, more especially polyacrylates and acrylic/maleic copolymers which have some function as water-softening agents and also inhibit unwanted deposition onto fabric from the wash liquor.

Where the tablet contains water soluble builder it is preferably present in an amount of from 10 to 80% by weight based on the total weight of the tablet or region thereof. Where the tablet contains water in-soluble builder it is preferably present in an amount of from 5 to 80% by weight based on the total weight of the tablet or region thereof.

Tablets comprising from 4 to 50% by weight of surfactant and from 5 to 80% by weight of builder are especially preferred for fabric washing tablets. Tablets comprising from 1 to 5% by weight of surfactant and from 50 to 98% by weight of detergency builder are especially preferred for machine dishwashing tablets.

For the avoidance of doubt, where a tablet is heterogenous, the percentage ranges for the components referred to herein may apply to the overall composition of the tablet, and/or to at least one region of the tablet.

Optional Bleach System

Tabletted compositions according to the invention may contain a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 85% by weight of the composition of the tablet or region thereof. If the tablet contains surfactant and detergency builder, the amount of peroxygen compound bleach is unlikely to exceed 45% by weight of the tablet or region, possibly not exceed 25% by weight of the tablet or region.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), now in widespread commercial use in conjunction with sodium perborate; and perbenzoic acid precursors. The quaternary ammonium and phosphonium bleach activators disclosed in U.S. Pat. Nos. 4,751,015 and 4,818,426 (Lever Brothers Company) are also of interest. Another type of bleach activator which may be used, but which is not a bleach precursor, is a transition metal catalyst as disclosed in EP-A-458 397, EP-A-458 398 and EP-A-549 272. A bleach system may also include a bleach stabiliser (heavy metal sequestrant) such as ethylenediamine tetramethylene phosphonate and diethylenetriamine pentamethylene phosphonate.

Optional Water-Soluble Disintegration-Promoting Particles

A tablet or a region of a tablet may contain water-soluble particles to further promote disintegration in addition to water-swellable particles required by this invention.

It is preferred that such optional water-soluble disintegration-promoting particles make up from 0.1 to 30% by weight of the composition of the tablet or region thereof, for example 2, 4 or 6% by weight up to 15%, 20%, 25% or 30 by weight of the tablet or region thereof. It is preferred that such disintegration-promoting particles make up from 4% to 20% by weight of the composition.

However, it is within this invention that the amount of such water-soluble disintegration-promoting particles is low, below 5% by weight of the tablet or region, reliance being placed on insoluble water swellable particles.

As will be explained further below, these disintegration-promoting particles which contain the above forms of sodium tripolyphosphate can also contain other forms of sodium tripolyphosphate or other salts within the balance of their composition.

A small proportion of the above mentioned soluble materials may also be included in granulated particles which may contain organic surfactant and/or detergency builder, in an amount of preferably 1 to 25% by weight, more preferably 3 or 5% to 10% or 15% by weight of these granulated particles.

Preferably the water-soluble particles to further promote disintegration comprise materials, other than soap or organic surfactant, selected from compounds containing at least 40% (by weight of the particles), better at least 50%, of one or more materials selected from the group consisting of; compounds with a water-solubility of at least 50 grams/100 grams in de-ionised water at 20° C.; or sodium tripolyphosphate containing at least 40% of its own weight of the phase I anhydrous form, or sodium tripolyphosphate which is partially hydrated so as to contain water of hydration in an amount which is at least 0.5% by weight of the sodium tripolyphosphate in the particles, better at least 1% by weight of the sodium tripolyphosphate in the particles.

As will be explained further below, these disintegration-promoting particles can also contain other forms of tripolyphosphate or other salts within the balance of their composition.

If the material in such water-soluble disintegration-promoting particles can function as a detergency builder, (as is the case with sodium tripolyphosphate) then of course it contributes to the total quantity of detergency builder in the tablet composition.

A solubility of at least 50 g/100 g of deionised water at 20° C. is an exceptionally high solubility: many materials which are classified as water soluble are less soluble than this.

Some highly water-soluble materials which may be used are listed below, with their solubilities expressed as grams of solid to form a saturated solution in 100 grams of deionised water at 20° C.:

| Material | Water Solubility (g/100 g) |
|---|---|
| Sodium citrate dihydrate | 72 |
| Potassium carbonate | 112 |
| Urea | >100 |
| Sodium acetate | 119 |
| Sodium acetate trihydrate | 76 |
| Magnesium sulphate 7H₂O | 71 |

By contrast the solubilities of some other common materials at 20° C. are:

| Material | Water Solubility (g/100 g) |
|---|---|
| Sodium chloride | 36 |
| Sodium sulphate decahydrate | 21.5 |
| Sodium carbonate anhydrous | 8.0 |
| Sodium percarbonate anhydrous | 12 |
| Sodium perborate anhydrous | 3.7 |
| Sodium tripolyphosphate anhydrous | 15 |

Preferably this highly water soluble material is incorporated as particles of the material in a substantially pure form (i.e. each such particle contains over 95% by weight of the material). However, the said particles may contain material of such solubility in a mixture with other material, provided that material of the specified solubility provides at least 40% by weight of these particles.

Preferred water-soluble materials having a solubility exceeding 50 g/100 g of deionised water at 20° C. are sodium citrate dihydrate, urea, sodium acetate and sodium acetate trihydrate. The sodium acetate may be in a partially or fully hydrated form. An especially preferred material is sodium acetate in a partially or fully hydrated form.

It may be preferred that the highly water-soluble material is a salt which dissolves in water in an ionised form. As such a salt dissolves it leads to a transient local increase in ionic strength which can assist disintegration of the tablet by preventing nonionic surfactant from swelling and inhibiting dissolution of other materials.

Specifically, tablets of this invention may contain water-soluble salt, with a solubility exceeding 50 grams/100 grams of deionised water at 20° C., both as a small percentage within the said granulated particles and as separate particles which are mixed with them.

Within granulated particles which may contain surfactant and/or builder, such highly water soluble salt may be present in an amount from 0 to 30% by weight of those particles, preferably from 3 to 10% or 15% thereof, while the materials added to those particles before tabletting may be such highly soluble salts in an amount from 2 or 5% up to 15% or 20% by weight of the whole tablet formulation.

The particles may comprise sodium tripolyphosphate with more than 40% (by weight of the particles), better 50% wt, of the anhydrous phase I form, and/or sodium tripolyphosphate which is partially hydrated so as to contain water of hydration in an amount which is at least 0.5% by weight, better 1% by weight, of the sodium tripolyphosphate. The level of hydration may lie in a range from 0.5 to 4% by weight, or, it may be higher. Indeed fully hydrated sodium tripolyphosphate may be used to provide these particles. Particles which contain this phase I form will often contain the phase I form of sodium tripolyphosphate as at least 50% or 55% by weight of the tripolyphosphate in the particles. It is possible that the particles contain at least 40 wt % sodium tripolyphosphate with the required phase I content but which is also sufficiently hydrated so as to contain at least 0.5% water by weight of the sodium tripolyphosphate.

Sodium tripolyphosphate is very well known as a sequestering builder in detergent compositions. It exists in a hydrated form and two crystalline anhydrous forms. These are the normal crystalline anhydrous forms, known as phase II which is the low temperature form, and phase I which is stable at high temperature. The conversion of phase II to phase I proceeds fairly rapidly on heating above the transition temperature, which is about 420° C., but the reverse reaction is slow. Consequently phase I sodium tripolyphosphate is metastable at ambient temperature.

A process for the manufacture of particles containing a high proportion of the phase I form of sodium tripolyphosphate by spray drying below 420° C. is given in U.S. Pat. No. 4,536,377. These particles should also contain sodium tripolyphosphate which is partially hydrated. The extent of hydration should be at least 0.5% by weight of the sodium tripolyphosphate in the particles. It may lie in a range from 1 to 4% by weight, or it may be higher. Indeed fully hydrated sodium tripolyphosphate may be used to provide these particles.

The remainder of the tablet composition used to form the tablet or region thereof may include additional sodium tripolyphosphate. This may be in any form, including sodium tripolyphosphate with a high content of the anhydrous phase II form. Suitable material is commercially available. Suppliers include Rhone-Poulenc, France and Albright & Wilson (now Rhodia), UK.

Some countries require that phosphate is not used. For such countries, a zero phosphate tablet in accordance with this invention may utilise a suitable amount, e.g. 15% by weight or more of disintegration-promoting material with solubility of at least 50 gram/100 gram at 20° C. Other countries permit the use, or at least some limited use, of phosphates, making it possible to use some sodium tripolyphosphate.

Optional Other Ingredients

Tablets of the invention may also contain one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by Gist-Brocades N. V., Delft, Holland, and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction to form a tablet.

The tablets of the invention may also contain a fluorescer (optical brightener), for example, Tinopal (Trade Mark) DMS or Tinopal CBS available from Ciba-Geigy AC, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material is advantageously included if organic surfactant is present, especially if a detergent tablet is primarily intended for use in front-loading drum-type automatic washing machines. Suitable antifoam materials are usually in granular form, such as those described in EP 266 863A (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material. Antifoam granules may be present in an amount up to 5% by weight of the composition of the tablet or region thereof.

It may also be desirable that a tablet of the invention includes an amount of an alkali metal silicate, particularly sodium ortho-, meta- or disilicate. The presence of such alkali metal silicates at levels, for example, of 0.1 to 10 wt %, may be advantageous in providing protection against the corrosion of metal parts in washing machines, besides providing some measure of building and giving processing benefits in manufacture of the particulate material which is compacted into tablets. A composition for fabric washing will generally not contain more than 15 wt % silicate. A tablet for machine dishwashing will frequently contain at least 20 wt % silicate.

Further ingredients which can optionally be employed in fabric washing detergent tablets of the invention include anti-redeposition agents such as sodium carboxymethylcellulose, straight-chain polyvinyl pyrrolidone and the cellulose ethers such as methyl cellulose and ethyl hydroxyethyl cellulose, fabric-softening agents; heavy metal sequestrants such as EDTA; perfumes; and colorants or coloured speckles.

Bulk Density and Particle Size

A tablet of this invention, or a discrete region of such a tablet, is a matrix of compacted particles.

While the starting particulate composition from which the tablets are produced may in principle have any bulk density, the present invention may be especially relevant to tablets of detergent composition made by compacting powders of relatively high bulk density, because of their greater tendency to exhibit disintegration and dispersion problems. Such tablets have the advantage that, as compared with a tablet derived from a low bulk density powder, a given dose of composition can be presented as a smaller tablet.

Thus the starting particulate composition may suitably have a bulk density of at least 400 grams/liter, preferably at least 500 grams/liter, and possibly at least 600 grams/liter.

Particle sizes can be controlled in the manufacturing process of any particles included in the composition. Oversize particles are usually removed by sieving (for example by a Mogensen screen) at the end of the production process, followed by milling and recycling of the removed oversize fraction. Undersize particles can also be removed by sieving, or if the manufacturing process employs a fluidised bed undersized particles may be entrained in the air stream and subsequently recovered from it for recycling to the granulation stage.

It is preferred that the average particle size of granulated particles forming the particulate composition from which the tablet is formed is between 200 and 2000 micrometers, more preferred between 400 and 1100 micrometers, such as between 500 and 1000 micrometers. Preferably no more than 5% of these particles is smaller than 200 micrometers while no more than 5% is larger than 1400 micrometers. Fine particles, smaller than 180 micrometers or 200 micrometers may be eliminated by sieving before tabletting, if desired, although we have observed that this is not always essential.

Materials which are mixed with the granulated particles may also comply with these requirements concerning particle size.

Producing the Non-compacted Powder

A composition which is compacted into a tablet or tablet region may contain particles which have been prepared by spray-drying or granulation and which contain a mixture of ingredients. Such particles may contain organic detergent surfactant and some or all of the water-softening agent (detergency builder) which is also present in a detergent tablet.

Granular detergent compositions of high bulk density prepared by granulation and densification in a high-speed mixer/granulator, as described and claimed in EP-A-340 013 (Unilever), EP-A-352 135 (Unilever), and EP-A-425 277 (Unilever), or by the continuous granulation/densification processes described and claimed in EP-A-367 339 (Unilever) and EP-A-390 251 (Unilever), are inherently suitable for use in the present invention.

Another particularly suitable process for the preparation of a high-bulk density detergent powder is described in WO-A-98/11193 (Unilever). In this document, a feedstock of the starting acid for production of the anionic surfactant is partially neutralised, for example by sodium hydroxide, before being fed into a high-speed mixer densifier (e.g. Lodige CB 30 Recycler) where the partially neutralised acid feedstock is completely neutralised, whilst being mixed with the majority of other components of the detergent base powder granule. This powder can be further densified by treating in a moderate speed mixer (e.g. Lodige KM 300 mixer), before which stage further detergency builder may be added. The water-soluble polymer material is preferably added before the further densification step, although it may be added in the first mixer. The water-soluble polymer material may be heated to a temperature considerably above its melting point to obtain a free-flowing liquid. The resulting powder can be cooled and dried using a fluid bed, after which any desired particle size control can be exercised.

Any separate particles containing further components of the finished formulation can be mixed with the base powder prior to compaction. Preferably, separate particles of the disintegration-promoting material required for this invention, and any optional water-soluble particles to promote disintegration, are mixed with the remainder of the particulate composition prior to compaction.

Product Forms and Proportions

The present invention may especially be embodied as a tablet for fabric washing which will generally contain, overall, from 5 to 50% by weight of surfactant and from 5 to 80% by weight of detergency builder (water softening agent). The water-swellable disintegration promoting particles of the invention may be present in an amount from 0.1% to 15% by weight of the composition. Peroxygen bleach may be present and if so is likely to be in an amount not exceeding 45% by weight of the total composition.

A homogenous tablet, or any region of a heterogenous tablet which contains water-swellable disintegration promoting particles in accordance with this invention will generally contain said particles in an amount from 0.1 to 15% by weight based on the total weight of the tablet or that region. An amount which is specifically envisaged is in the range from 2 to 6% by weight.

In the case of a heterogenous tablet, a region which contains water-swellable disintegration promoting particles in accordance with this invention may also contain surfactant in an amount which is from 5 to 50% by weight of that region and detergency builder in an amount which is from 5 to 80% by weight of that region.

The invention may be embodied as tablets whose principal or sole function is that of removing water hardness. In such tablets the water-softening agents, especially water-insoluble aluminosilicate, may provide from 50 to 98% of the tablet composition. A water-soluble supplementary builder may well be included, for instance in an amount from 2% to 30 wt % of the composition, or may be considered unnecessary and not used. Water-softening tablets embodying this invention may include some surfactant.

The invention may be embodied as tablets for machine dishwashing. Such tablets typically contain a high proportion of water soluble salts, such as 50 to 95% by weight, at least some of which, exemplified by sodium citrate and sodium silicate, have water-softening properties.

Both water-softening and machine dishwashing tablets may include nonionic surfactant which can act as a lubricant during tablet manufacture and as a low foaming detergent during use. The amount may be small, e.g. from 0.5% by weight of the composition up to 3% or 5% by weight.

Tablets for use as a bleaching additive will typically contain a high proportion of peroxygen bleach, such as 10 to 85% by weight of the composition. This may be mixed with other soluble salt as a diluent. The composition of such a tablet may well include a bleach activator such as tetraacetylethylene diamine (TAED). A likely amount would lie in the range from 1 to 20% by weight of the composition.

In the case of tablets for bleaching, machine dishwashing or water-softening tablet, a homogenous tablet, or any region of a heterogenous tablet which contains the water-swellable disintegration promoting particles of this invention, will generally contain them in an amount from 0.1 to 10%, preferably not over 8% by weight of the tablet or region. Such a tablet or region may contain surfactant in small amount, such as from 0.5 to 3% or 5% by weight as mentioned above.

Tabletting and Tablet Properties

A composition which is to be compacted into a tablet or tablet region can be prepared by mixing the disintegration-promoting particles of the invention with any other particulate ingredients so as to form a particulate cleaning composition. Notably, these particulate ingredients may other include water-soluble particles to promote disintegration. Compaction may suitably occur by compacting a quantity of the particulate composition in a mould to form a tablet or region of a tablet.

A variety of tabletting machinery is known, and can be used. Generally it will function by stamping a quantity of the particulate composition which is confined in a die. Tabletting may be carried out above, at or below ambient temperature. Above ambient temperature may allow adequate strength to be achieved with less applied pressure during compaction. In order to carry out the tabletting at a temperature which is below or above ambient, the particulate composition is preferably supplied to the tabletting machinery at a reduced or elevated temperature. This will of course supply cooling or heat to the tabletting machinery, but the machinery may be cooled or heated in some other way also. If any heat is supplied, it is envisaged that this will be supplied conventionally, such as by passing the particulate composition through an oven, rather than by any application of microwave energy.

The size of a tablet will suitably range from 10 to 160 grams, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids.

The overall density of a tablet for fabric washing preferably lies in a range from 1040 or 1050 gram/liter preferably at least 1100 gram/liter up to 1400 gram/liter. The tablet density may well lie in a range up to no more than 1350 or even 1250 gram/liter. The overall density of a tablet of some other cleaning composition, such as a tablet for machine dishwashing or as a bleaching additive, may range up to 1700 gram/liter and will often lie in a range from 1300 to 1550 gram/liter.

The strength of the tablets, in their dry state as made on the compaction press, can be determined according to their diametrical fracture stress DFS, which is calculated from the equation:

$$DFS = \frac{2 {F}_{max}}{π Dt}$$

where DFS is the diametrical fracture stress in Pascals, Fₘₐₓ is the applied load in Newtons to cause fracture, D is the tablet diameter in meters and t is the tablet thickness in meters. The test is carried out using an Instron type universal testing instrument to apply compressive force on a tablet diameter (i.e. perpendicular to the axis of a cylindrical tablet). It is preferred that tablets have a DFS of at least 20 kPa, more preferably at least 25 kPa, such as 30 kPa or above.

The invention will be further exemplified by the following examples. Further examples within the scope of the present invention will be apparent to the person skilled in the art.

### EXAMPLES

### Examples 1 to 5

Preparation of the Disintegrant Particles

Disintegrant particles according to the invention were prepared by the following method and had the compositions as given in Table 1.

TABLE 1
disintegrant particles

| | Ex. 1 | Ex. 2 | Ex. 3 | Ex. 4 | Ex. 5 |
|---|---|---|---|---|---|
| | % by wt | % by wt | % by wt | % by wt | % by wt |
| Cocopeat | 15 | 25 | 40 | 60 | 80 |
| powder*¹ | | | | | |
| Bentonite | 85 | 75 | 60 | 40 | 20 |
| Clay*² | | | | | |
| Total | 100% wt | 100% wt | 100% wt | 100% wt | 100% wt |

*¹Cocopeat milled to an average particle size of less than 120 microns prior to incorporation in the example.
*²Bentonite clay powder, available as QPN200 from Colin Stewart Minchem.

The disintegrant particles were prepared by mixing together in the stated proportions the cocopeat powder and the clay and then compacting the mixture in a Carver compacting machine using a compaction pressure of 3000 kg or 6000 kg at 15% speed with a 1 minute dwell-time and using a 45 mm diameter die. For each of examples 1 to 5, one set of disintegrant particles (examples 1A to 5A) were made at 3000 kg and another set (examples 1B to 5B) were made at 6000 kg. This compacted material was then milled in a IKA milling machine and the resultant granules were sieved to isolate the fraction in the particle size range 500-1400 microns. The particles in this sieved fraction were used in examples 6 to 10.

### Examples 6 to 10 and Comparative Example A

A detergent base powder was prepared according to the formulation given in Table 2. The base powder formulation was made using known granulation technology to produce a base powder. The fluorescer and subsequent ingredients were post added to the granulated base powder to produce the detergent base powder.

TABLE 2
detergent base powder.

| | % by |
|---|---|
| Ingredient | Weight |
| Sodium linear alkylbenzene sulphonate | 12.34 |
| nonionic surfactant (C13-15 branched fatty | 3.53 |
| alcohol 7EO) | |
| nonionic surfactant (C13-15 branched fatty | 1.89 |
| alcohol 3EO) | |
| Soap | 0.94 |
| zeolite A24*³ | 27.6 |
| Sodium acetate trihydrate | 3.53 |
| Sodium carbonate | 4.1 |
| sodium carboxymethyl cellulose (SCMC) (69% wt | 0.55 |
| active) | |
| Moisture and NDOM*⁴ | 4.97 |
| Fluorescer adjunct | 2.17 |
| Sokalan HP23 (18% wt active soil release | 1.45 |
| polymer)*⁵ | |
| Sodium citrate dihydrate | 5.07 |
| TAED granules, (83% active) | 5.44 |
| Sodium Percarbonate (coated)*⁶ | 20.3 |
| Sodium silicate granules (80% active) | 4.35 |
| EDTMP granulate (Dequest 2047)*⁷ | 1.04 |
| EHDP granulate (Dequest 2016)*⁸ | 0.72 |
| Total | 100 |

*³Zeolite A24 is maximum aluminium zeolite P ex Crosfield (now Ineos Silicas, UK).
*⁴NDOM is non-detergent organic matter
*⁵Sokalan HP23 is a grafted co-polymer of polyethylene oxide and polyvinylacetate available from BASF
*⁶coated percarbonate available from Interox
*⁷Dequest 2047 is ethylene diamine tetra methylene phosphonate available from Monsanto
*⁸Dequest 2016 is ethylene hydroxy diphosphonate available from Monsanto

The amount of zeolite MAP (zeolite A24) in the table above is the amount which would be present if it was anhydrous. Its accompanying small content of moisture is included as part of the moisture and minor ingredients. Sodium carboxymethyl cellulose is a commonly used water-soluble antiredeposition polymer.

To 90 gram portions of this detergent base powder was added 5 grams sodium acetate trihydrate and 5 grams of the disintegrant particles as detailed in Table 3 to produce examples 6 to 10. The two sets of disintegrant particles, one formed at 3000 kg per 15.2 cm² and one formed at 6000 kg per 15.2 cm², were used to produce an A set and a B set of each of examples 6 to 10 and A. Set A used the disintegrant particles formed at 3000 kg per 15.2 cm² and set B used the disintegrant particles formed at 6000 kg per 15.2 cm². The compositions were well mixed. Comparative example A was formed by adding to a 95 gram portion of the above detergent base powder 5 grams of sodium acetate trihydrate. Thus examples 6A and 6B to 10A and 10B were so formed. The example numbers 1 to 5 in the table below refer to the disintegration-promoting particle as formed in examples 1 to 5 above.

TABLE 3
examples 6 to 10 and comparative example A.

| | Ex. 6 | Ex. 7 | Ex. 8 | Ex. 9 | Ex. 10 | Ex. A |
|---|---|---|---|---|---|---|
| | % wt | % wt | % wt | % wt | % wt | % wt |
| Base powder | 90.0 | 90.0 | 90.0 | 90.0 | 90.0 | 95.0 |
| Na acetate | 5.0 | 5.0 | 5.0 | 5.0 | 5.0 | 5.0 |
| trihydrate | | | | | | |
| Ex 1 | 5.0 | — | — | — | — | — |
| Ex 2 | — | 5.0 | — | — | — | — |
| Ex 3 | — | — | 5.0 | — | — | — |
| Ex 4 | — | — | — | 5.0 | — | — |
| Ex 5 | — | — | — | — | 5.0 | — |
| total | 100 | 100 | 100 | 100 | 100 | 100 |

40g portions of each composition were made into cylindrical tablets of 44.7 mm diameter and height 19-20 mm using a Graseby Specac laboratory tabletting machine.

The compaction pressure used for each tablet was adjusted so that the tablets were all compacted to the same diametrical fracture stress of 30 kPa.

The strength of the tablets, in their dry state as made on the press, was determined as their diametrical fracture stress DFS by the method detailed in the description of the invention above.

The speed of disintegration of the tablets was measured under static conditions. A pre-weighed tablet was placed on a metal grid with 1×1 cm mazes and the tablet and grid immersed in 15° French Hardness tap water at 20° C. so that 2 cm of water was above the top of the immersed tablet. After 60 seconds the metal grid is carefully taken out of the water and the wet tablet residue weighed. The % disintegration is the % weight loss of the tablet. If the tablet had fully disintegrated in this time then the time taken for 100% disintegration is recorded. The results are given in table 4 below.

TABLE 4
disintegration results

| Example | % disintegration after 60 seconds |
|---|---|
| Comparative A | −14%, absorbed water but did not |
| | disintegrate |
| 6A | 18% |
| 6B | 25% |
| 7A | 10% |
| 7B | 34% |
| 8A | 32% |
| 8B | 46% |
| 9A | 59% |
| 9B | 64% |
| 10A | Tablet didn't compress well. |
| 10B | 78% |

The above results demonstrate that the disintegrant particles of the invention provide good disintegration of a detergent tablet across a range of weight ratios of carrier:disintegrant in the particles, and, when the disintegrant granules are formed at different compaction pressures.

### Example 11

In the disintegrant promoting particles of examples 1 to 5, the cocopeat can be replaced with powdered wood to produce particles comprising a disintegrant material of the type (ii) as described herein. Small wood chips, as sold for animal litter, may be milled to powder (e.g. in a kitchen blender) and the resulting powder, which resembles sawdust, sieved to remove any particles larger than 2,000 micrometers. The sievings are used to produce the particles.

### Example 12

A machine dishwashing composition can be prepared by mixing together the following constituents.

| Ingredient | % by Weight |
|---|---|
| Sodium disilicate | 16.3 |
| Sodium carbonate | 28.8 |
| Sodium citrate dihydrate | 29.6 |
| Nonionic surfactant (C13-15 branched fatty | 1.2 |
| alcohol 7EO) | |
| Sodium perborate | 11.2 |
| TAED granules (83% active) | 3.8 |
| Enzymes | 3.2 |
| Polymer sequestrant and minor ingredients | 5.9 |
| Total | 100 |

The disintegrant particles of examples 1 to 5 can be mixed into portions of the above composition in quantities of 1-10% by weight to produce compositions that can be compacted to produce machine dishwashing compositions.

1. A tablet of compacted particulate cleaning composition comprising at least one cleaning ingredient selected from the group consisting of organic surfactant, detergency builder and bleach, wherein the tablet or a discrete region thereof comprises water-swellable disintegration-promoting particles, the water-swellable disintegration-promoting particles comprising;
a) disintegration material selected from the group consisting of (i) cellulosic material from a plant source other than timber and (ii) plant material which comprises both cellulose and lignin, obtainable by fragmentation of plant material without separation of its fibers into a liquid dispersion, and
b) carrier material having a solubility in deionised water at 20° C. of about 1 gram per liter or less.

2. The tablet according to claim 1 wherein the disintegration material a) comprises at least about 35% by weight lignin.

3. The tablet according to claim 1 wherein the disintegration material a) comprises coconut husk material.

4. The tablet according to claim 1 wherein the disintegration material a) comprises a material selected from the group consisting of powdered wood and wood chips.

5. The tablet according to claim 1 wherein the disintegration material a) has an average particle size of about 120 micrometers or below before it is combined with the carrier material b) to form the water-swellable disintegration-promoting particles.

6. The tablet according to claim 1 wherein the carrier material b) comprises a water-insoluble material.

7. The tablet according to claim 1 wherein the carrier material b) comprises a clay.

8. The tablet according to claim 7 wherein the clay is a smectite clay.

9. The tablet according to claim 1 wherein the disintegration material a) comprises coconut husk material and the carrier material b) comprises a clay.

10. The tablet according to claim 1 wherein the water-swellable disintegration-promoting particles comprise the disintegration material a) and the carrier material b) in a weight ratio of from about 15:85 to about 85:15.

11. The tablet according to claim 1 wherein the water-swellable disintegration-promoting particles comprise the disintegration material a) in an amount of from about 15% to about 80% by weight based upon the total weight of the water-swellable disintegration-promoting particles.

12. The tablet according to claim 1 wherein the water-swellable disintegration-promoting particles comprise the carrier material b) in an amount of from about 20% to about 85% by weight based upon the total weight of the water-swellable disintegration-promoting particles.

13. The tablet according to claim 1 wherein the water-swellable disintegration-promoting particles further comprise a binder material.

14. The tablet according to claim 13 wherein the binder material is present in the water-swellable disintegration-promoting particles in an amount of from about 0.1% to about 10% by weight based upon the total weight of the water-swellable disintegration-promoting particles.

15. The tablet according to claim 1 wherein the water-swellable disintegration-promoting particles are present in the tablet in an amount of from about 0.5 to about 10% by weight based on the total weight of the tablet.

16. The tablet according to claim 1 wherein the water-swellable disintegration-promoting particles have an average particle size in the range from about 250 to about 1,500 micrometers.

17. The tablet according to claim 1 wherein the tablet has a plurality of discrete regions, and wherein at least one of the discrete regions comprises a greater concentration of the water-swellable disintegration-promoting particles than another discrete region of the tablet.

18. The tablet according to claim 1, wherein the carrier material b) is lighter in colour than the disintegration material a).

19. A process for making a tablet of compacted particulate cleaning composition or a region thereof comprising at least one cleaning ingredient selected from the group consisting of organic surfactant, detergency builder and bleach, and further comprising water-swellable disintegration-promoting particles, the water-swellable disintegration-promoting particles comprising a) disintegration material selected from the group consisting of (i) cellulosic material from a plant source other than timber and (ii) plant material which contains both cellulose and lignin, obtainable by fragmentation of plant material without separation of its fibers into a liquid dispersion and b) carrier material having a solubility in deionised water at 20° C. of about 1 gram per liter or less, the process comprising the steps of;
1) mixing the water-swellable disintegration-promoting particles with other particulate ingredients of a particulate cleaning composition to form a particulate cleaning composition, and
2) compacting a quantity of the particulate cleaning composition in a mould to form the tablet of compacted particulate cleaning composition or the region thereof.

20. A water-swellable tablet disintegration-promoting particle comprising;
a) disintegration material selected from the group consisting of (i) cellulosic material from a plant source other than timber and (ii) plant material which contains both cellulose and lignin, obtainable by fragmentation of plant material without separation of its fibers into a liquid dispersion, and
b) carrier material having a solubility in deionised water at 20° C. of about 1 gram per liter or less.

21. A process for making water-swellable tablet disintegration-promoting particles comprising a) disintegration material selected from the group consisting of (i) cellulosic material from a plant source other than timber and (ii) plant material which contains both cellulose and lignin, obtainable by fragmentation of plant material without separation of its fibers into a liquid dispersion, and b) carrier material having a solubility in deionised water at 20° C. of about 1 gram per liter or less, the process comprising the steps of;
1) contacting the disintegration material a) with the carrier material b) to produce a mixture, and
2) compacting the mixture to produce the water-swellable tablet disintegration-promoting particles.
